(19) United States
(12) Patent Application Publication
(10) Pub. No.: US 2016/0216773 A1
(43) Pub. Date: Jul. 28, 2016

(54) Virtual Object Control Method and the Portable Device

(71) Applicants: Yi-Chuan CHENG, Yongjing Township (TW); Kuo-Ching CHIANG, New Taipei City (TW)

(72) Inventors: Yi-Chuan CHENG, Yongjing Township (TW); Kuo-Ching CHIANG, New Taipei City (TW)

(21) Appl. No.: 14/604,722

(22) Filed: Jan. 24, 2015

(51) Int. Cl. G06F 3/038; G06F 3/0346; G06F 3/0485

(52) U.S. Cl. CPC G06F 3/038; G06F 3/0485; G06F 3/0346

(57) ABSTRACT

The present invention includes an inert unit and an instruction analysis module within a portable device to control a virtual object displayed on the portable device.

### TECHNICAL FIELD

The present invention relates to a portable device, such as smart phone, digital image capturing device or tablet computer, and more particularly, to a method for inertial input command.

### BACKGROUND OF RELATED ART

In general, electronic products market is constantly expanded, and the electronic products with more and more different designs and functions can be provided for consumer's choice. In order to meet the requirement for individual user, performance and application of the electronic products will be promoted and developed with its short life cycle, in order to meet the market trend. Therefore, portable and useful multimedia devices are appeared in the marketing.

The current multimedia devices include handheld TV, LCD TV, movie player, music player, mobile storage devices. Multimedia devices are mainly used for playing music, displaying pictures, playing movies and processing image data or video data. Images and image data can be zoomed and rotated to achieve a better presentation, and conveniently browsing. However, with the increasing demand for audio/video digital products, multimedia devices have been developed with more functions to meet the market demand. At present, all of portable devices are using a finger touch for inputting command. But, if using single hand for operation, it is not convenient for touch controlling virtual objects, and the traditional portable devices unfavorable single hand operation. In view of the above description, this invention provides a portable device with an atypical command input to meet the required demand.

### SUMMARY

The invention has been described some embodiments. It should be noted that from the following discussion, alternative embodiments of the structures and methods disclosed herein will be readily recognized as viable alternatives that may be employed without departing from the principles discussed herein.

The present invention proposes a method of inertial input command, comprising: configuring an inertial device and an inertial command analysis module into a portable device, wherein the inertial device and the inertial command analysis module are coupled to a control unit of the portable device; triggering a touch point or a physical key of the portable device; moving the portable device for the inertial device detecting at least a movement direction of the portable device; creating a movement information by the inertial device to feed into the inertial command analysis module for analyzing; creating a corresponding command based-on the analyzing to feed into the control unit; and performing the corresponding command.

According to one aspect of the invention, the movement direction is a first direction for downward scrolling page, and the first direction is upward.

According to another aspect of the invention, the movement direction is a second direction for upward scrolling page, and the second direction is downward.

According to one aspect of the invention, the movement direction is a third direction for rightward scrolling page, and the third direction is leftward.

According to one aspect of the invention, the movement direction is a fourth direction for leftward scrolling page, and the first direction is rightward.

According to one aspect of the invention, the movement direction is a fifth direction for image magnification, and the fifth direction is away from a user.

According to one aspect of the invention, the movement direction is a sixth direction for image reduction, and the sixth direction is closer to a user.

According to one aspect of the invention, the above mentioned movement direction and specified command are changed based-on the requirement of practice.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a block diagram of a portable device according to the present invention.

FIG. 2 illustrates a process flow of a method according to the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

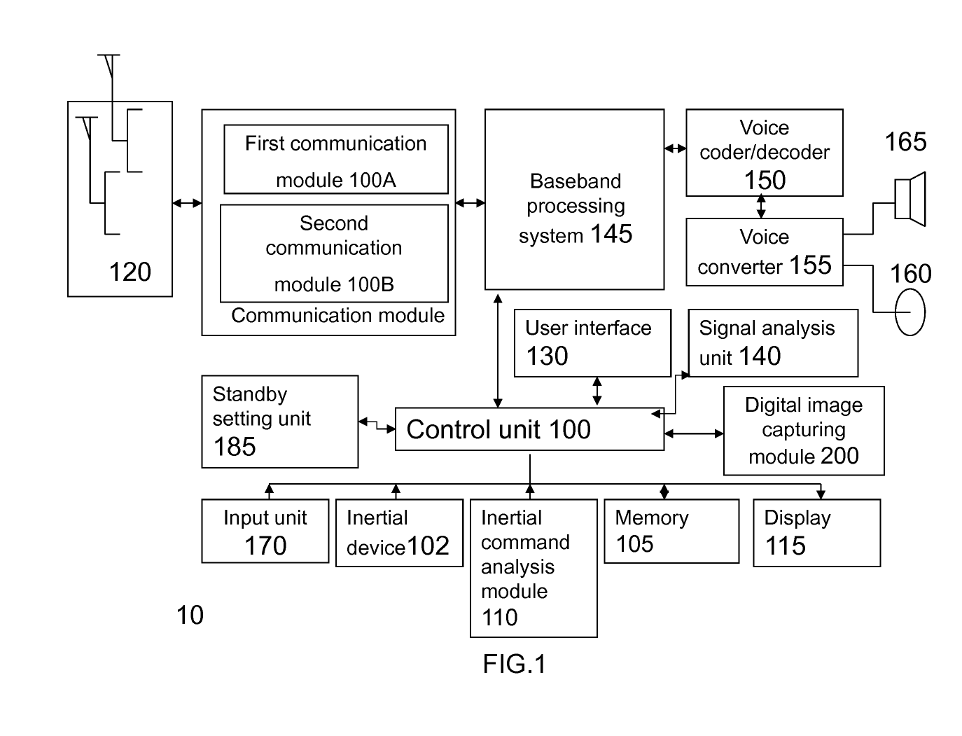

FIG. 1 is a functional diagram depicting an exemplary portable device 10 of the invention. The portable device 10 can be any of a variety of computing devices, such as cell phones, smart phones, digital cameras, tablet PCs etc. Referring to FIG. 1, cell phone is for illustration but not to limit the present invention, although not all connections are shown, for ease of illustration. In other words, some modules for different communication systems or protocols can be modified in the present invention to facilitate the implementation, which are without departing from the spirit of the invention. For example, chips and processor can be integrated onto a system on chip. The portable device includes a control unit 100, such as a central processor, for processing and controlling command and data of the portable device, data processing and computing. A memory 105 is coupled to the control unit 100. Memory 105 of the wireless communication device can usually contain non-volatile memory, such as flash memory. General system operation software or applications can be stored in non-volatile memory, wherein internal data may still retain in absence of power, and can be read or written repeatedly during power providing. System programs and applications stored in non-volatile memory may control execution of all necessary functions, and further processed by the central processing unit or control unit and through a user interface 130 to display on the display 115. An input unit 170 is electrically connected to the control unit 100 to facilitate the user to input commands/instructions or data. The input unit 170 may be generally physical buttons or touch panel.

Antenna system 120 may be a multi-band antenna or consisted of multiple antennas, depending on demand, which may be a dipole antenna, a planar antenna, an inverted-F antenna, fractal antennas. Antenna system 120 is used to receive signals and coupled to a communication module capable of transmitting information in motion, which generally mixes local oscillating signals by a receiver to convert the signals to an intermediate frequency (IF) signal. A transmitter is used to convert the modulated signal to the preset frequency range of the protocol, and transmitting via the antenna system. Modulator and demodulator (MODEM) are electrically coupled to the receiver and the transmitter to modulate or de-modulate the signals. The above-mentioned protocol includes but not limited to, International Telecommunications Unit (ITU): 3G, 3.5G, 4G, W-CDMA, CDMA2000, CDMA2001, TD-CDMA/TD-SCDMA, UWC-136, DECT, GSM, or PHS. A baseband processor is coupled to the MODEM, which can process signals of preset bandwidth and protocol.

A second communication module 100B is used for low-speed or fixed-point transmission. In a preferred embodiment, the second communication module may comprise a wireless wideband local area network module coupled to the control unit to facilitate wireless transmission signals (sending/receiving) through the antenna and contacting to network hotspots or access point. The illustrated second communication module 100B comprises WiFi, Worldwide Interoperability for Microwave Access (WiMax), 802.11x (a, b, g, n). An internet video communication unit is coupled to the control unit 100 for processing of voice data or information transmitted via Internet. Image data and voice data can be processed by the internet video communication unit and simultaneously transmitted via Internet for internet video communication. The above mentioned internet video communication unit may be a hardware, firmware or software architecture. Files can be downloaded by the second communication module 100B without using computer. In the motion of the portable device or in the case of weak signal or no signal of communication, based-on analysis and determination of a signal analysis unit 140, a switching unit connected to the control unit 100 may be used to switch to the first communication module 100A for performing the desired function. The switch function can be performed by manually switching or automatically switching by software.

The first communication module 100A is coupled to a baseband processing system 145. The baseband processing system 145 is an integrated chip, or complex baseband processors, and coupled to a long distance communication module with corresponding protocol in order to process communication signals. Signals are received by using an antenna, and local oscillating signals are received by a receiver to convert as intermediate frequency (IF) signals. A transmitter is used to convert frequency of the modulated signals, and transmitting signals via antenna. Modulator and demodulator (MODEM) are connected to the receiver and the transmitter for modulating signals. Each of the above mentioned video communication modules is electrically coupled to the control unit respectively, wherein each module can be fabricated by integrated circuit manufacturing technology, and all modules can be integrated together or fabricated by system on chip architecture.

Signals are processed by the baseband processor, wherein control signal is sent to the control unit 100 for processing, and speech (voice) signal is transmitted to voice CODEC 150 for processing. Then, a voice converter (speech conversion) 155 is electrically connected to the CODEC 150 to convert digital signal into analog signal, or on the contrary analog-to-digital. A microphone 160 and a speaker 165 are electrically connected to the voice converter (speech conversion) 155, respectively. Card connector coupled to the control unit 100 is used for the insertion of separable or external module, such as SIM card, identity authentication card, wireless near field transaction card, worldwide interoperability for microwave access module card. For example, wireless near field transaction card is coupled to the control unit 100 for performing wireless transaction and access. In addition, the invention can also include a digital image capturing module 200 connected to the control unit 100 such that the captured image can be processed by the control unit 100. The digital image capturing module 200 can be CMOS or CCD array. The wireless communication device comprises a standby setting unit 185 electrically coupled to the control unit 100 for use's operation. When difference of transmission signal intensity between two different communication network service providers exceeds a critical value, the wireless communication device starts manually or automatically to transmit signal via a communication system with stronger transmission signal by standby setting unit 185. For example, received signal strength of communication network (system) service providers at user locality is compared by the signal analysis unit 140, selecting a communication system of communication network service provider with stronger signal from multiple telecommunication systems as communication system for transmitting signal.

Antenna and its corresponding RF unit can be configured by one or more units. This design can be configured for at least two different telephone numbers in a device. Based-on two telephone number possibly using different telecommunication network service providers, this wireless communication device includes a standby setting unit 185 electrically coupled to the control unit 100 to facilitate operation of user. When difference of transmission signal strength of a communication network exceeds a threshold value, the wireless communication device activates to transmit signal via a communication system with stronger signal by the standby setting unit 185. For example, the standby setting unit 185 may compare received signal strength of the communication system service providers at user location. A communication system of communication network service provider with stronger signal is selected from multiple telecommunication systems as communication system for transmitting signal. The present invention includes standby setting unit may be a program embedded in the memory of the wireless communication device in order to set standby mode, which can be a multi-mode standby or a single-mode standby.

The embodiment can be used for wireless communication device with multiple communication systems for signal transmission, and the wireless communication device comprises a portable device with complex protocol modules to provide more than two kinds of video systems simultaneously. Communication service provider may be a communication network service provider with a specified communication protocol. Messages (signals) received through two-way communication module and transmitted by a communication network service provider can be converted to recognizable signals by a decoder for decoding, which may be processed by microprocessor or central processing unit of the wireless communication device. The communication device includes at least two different communication systems which can simultaneously standby or separately standby. When user opens power of communication device, the communication device will search and scan network signal and its strength. The preset communication network system can also be switched or multiple communication network systems are standby simultaneously. For user to dial the phone, built-in program of the wireless communication device will perform interpretation to confirm which communication system or network as a medium of communication. The parameters of this interpretation can be set based-on signal strength, when a communication network signal is stronger, then the wireless communication device will initiate a communication system with stronger signal for transmitting signal. Method of transmitting signal of the wireless communication device includes relevant parameters of the communication system of the communication device; for example, the relevant parameters contain signal strength, comparison strength of signals received by the communication system service providers at user's location. Comparison of electromagnetic wave intensity may also be used as the basis to determine Based-on comparison of preset (default) conditions of the related parameters, a communication system may be selected as a communication system for transmitting signals. For example, the default conditions may be set by a communication system with relatively stronger signal strength as the communication system for transmitting signals. For example, it is performing a comparison of signal intensity for communication network service providers to determine which has relatively stronger signal strength at user's location. A communication system may be selected by multiple communication systems as the communication system for transmitting signals. Signals may be transmitted based on the selected communication system. The default condition is set to select the communication system with lower fee rate.

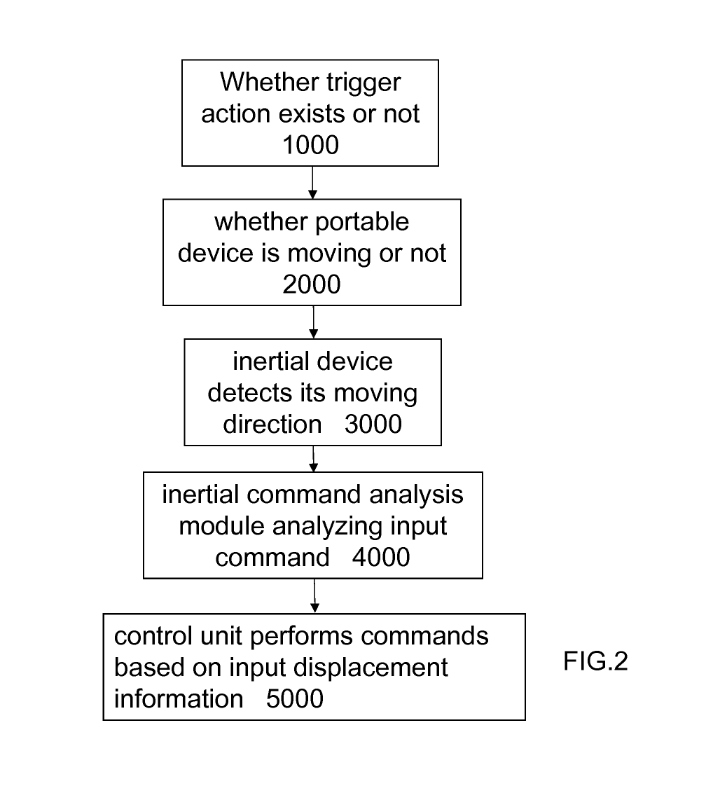

The portable device includes an inertial device 102 and an inertial command analysis module 110, which are coupled to the control unit 100. The inertial device 102 uses a displacement mode input command, as shown in FIG. 1 and FIG. 2. It is used as a control of actuation of the portable device, for example upward scrolling page, downward scrolling page, forward flipping page, backward flipping page, image enlargement, image reduction. In the prior art, button is used to control the volume. The invention does not need to key or button for input instruction for convenient single hand operation. The traditional portable devices are using indicating input device (such as keys) to control functions of the portable devices. In another embodiment, the inertial device 102 is using G sensor as a command input unit. For example, biaxial G sensor can be used to sense longitudinal and lateral acceleration as an input instruction of signal. In another example, three-axis sensor can detect vertical acceleration, in order to facilitate multi-direction command input. The sensor may be manufactured and designed by a single-chip CMOS integrated circuit to be as a complete biaxial acceleration measurement system. Acceleration sensor is used to measure value and direction of gravity acceleration. Sensing principle includes air mass mode and gravity block mode. For example air mass mode, the sensor is employing a movable heat convection air mass as a gravity block. Acceleration is determined by change in internal temperature of IC caused by acceleration. In addition, gyroscope can be used to analyze of direction and angle of movement. In another example, the inertial command analysis module 110 can be used to analyze input commands to perform.

Referring to FIG. 2, it shows a process flow of a method of the invention. Firstly, in step 1000, user is using a finger to touch a touch panel or a physical key, and the inertial command analysis module 110 determines (analyzes) whether the trigger action exists or not. If the trigger action exists, in step 2000, it determines whether the portable device is in movement or not, for example up, down, left, right, front, back moving a distance (displacement). Then, in step 3000, the inertial device 102 detects its moving direction and angle of the portable device. In step 4000, its information is fed into the inertial command analysis module 110 for analyzing input command to determine that direction of the movement is upward, downward, leftward, rightward, forward, backward, to trigger specific instruction (command) For example, upward means downward scrolling; downward means upward scrolling; rightwards means left page turning; leftwards means right page turning; away from the user (backward) means amplification; closer to the user (forward) means reduction. Then, in step 5000, the control unit can perform the above instructions (commands) based on the input displacement information. Therefore, users need not to slide page or image by finger and can control virtual objects by single hand.

According to an aspect of the invention, it can provide many advantages such as, the present invention providing a portable device with input instructions of inertial device, which can trigger or drive directionally specific function by single hand.

It will be understood that the above descriptions of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

1. A method of inertial input command, comprising:
configuring an inertial device and an inertial command analysis module into a portable device, wherein said inertial device and said inertial command analysis module are coupled to a control unit of said portable device, wherein said portable device is a smart phone or a tablet computer;
triggering a touch point of a touch panel of said portable device;
moving said portable device for said inertial device detecting at least a movement direction of said portable device;
creating a movement information of said portable device by said inertial device to feed into said inertial command analysis module for analyzing;
creating a corresponding command based-on said analyzing to feed into said control unit; and
performing said corresponding command.

2. The method as set forth in claim 1, wherein said movement direction is a first direction for downward scrolling page.

3. The method as set forth in claim 2, wherein said first direction is upward.

4. The method as set forth in claim 1, wherein said movement direction is a second direction for upward scrolling page.

5. The method as set forth in claim 4, wherein said second direction is downward.

6. The method as set forth in claim 1, wherein said movement direction is a third direction for rightward scrolling page.

7. The method as set forth in claim 6, wherein said third direction is leftward.

8. The method as set forth in claim 1, wherein said movement direction is a fourth direction for leftward scrolling page.

9. The method as set forth in claim 6, wherein said fourth direction is rightward.

10. The method as set forth in claim 1, wherein said movement direction is a fifth direction for image magnification.

11. The method as set forth in claim 10, wherein said fifth direction is away from a user.

12. The method as set forth in claim 1, wherein said movement direction is a sixth direction for image reduction.

13. The method as set forth in claim 12, wherein said sixth direction is closer to a user.
